(19) United States
(12) Patent Application Publication
(10) Pub. No.: US 2001/0043709 A1
(43) Pub. Date: Nov. 22, 2001

(54) Hearing aid fitted with a rechargeable battery, and application of such a rechargeable battery

(76) Inventor: Frank Panitzsch, Grossmonra OT Burgwenden (DE)

Correspondence Address: RANKIN, HILL, PORTER & CLARK, LLP, 700 HUNTINGTON BUILDING, 925 EUCLID AVENUE, CLEVELAND, OH, 44115-1405, US

(21) Appl. No.: 09/860,159

(22) Filed: May 17, 2001

(30) Foreign Application Priority Data
May 17, 2000 (DE) 100 23 907.2

(51) Int. Cl. H04R 25/00

(52) U.S. Cl. 381/330; 381/322; 381/323

(57) ABSTRACT

A hearing aid (1) having a case (3) enclosing its electrical components, which includes at least one rechargeable battery (10). The rechargeable battery is a planar solid-state rechargeable battery or a foil rechargeable battery.

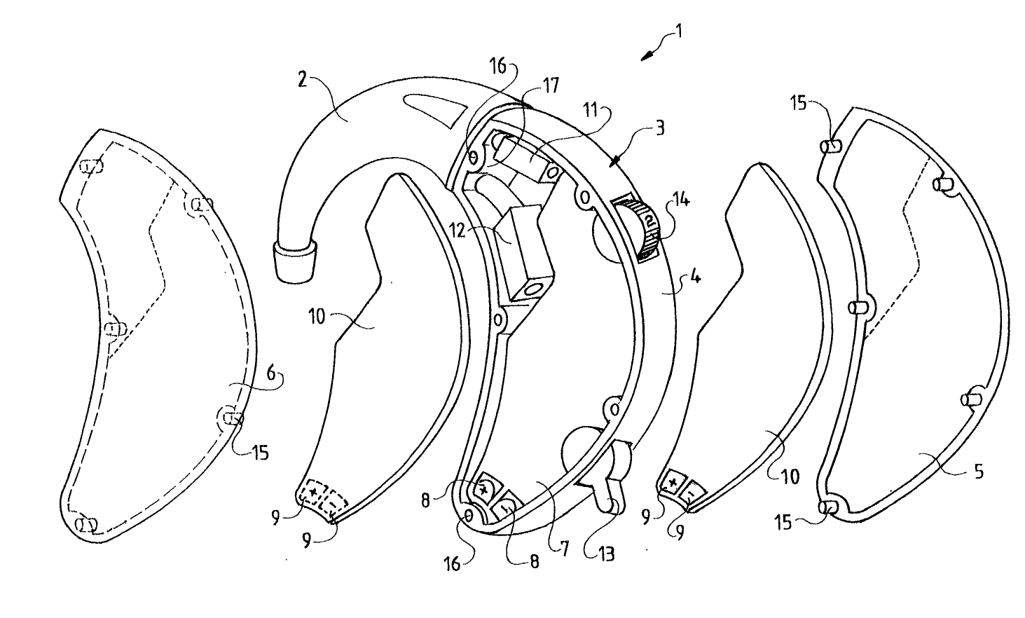

### BACKGROUND OF THE INVENTION

1. Field of the Invention

The invention relates to a hearing aid fitted with a rechargeable battery and further to the use of a planar solid-state rechargeable battery or a foil rechargeable battery to power a hearing aid.

2. Description of Related Art

In general a hearing aid includes a microphone, an amplifier, a loudspeaker or ear phone, operating elements such as ON/OFF switches and a volume control, an ear hook and ear adapter, and a power source.

Conventional power sources used for such hearing aids are, for instance, button cells with a service life of several days or small rechargeable batteries with service lives of about twelve hours, these small rechargeable batteries also being in the form of a button cell.

Hearing aids demand maximum compactness and minimum weight in order to be comfortable, unobtrusive, and easy to wear. This is especially the case for the so-called behind-the-ear hearing aids and the hearing glasses, furthermore to the still smaller in-ear hearing aids, which are accommodated directly in the auditory canal.

However, the rechargeable batteries used so far suffer from inadequate energy density and, moreover, are available only in particular sizes and shapes. These batteries are, as a rule, cylindrical button cells, which interferes with the compactness and ease of wearing of these hearing aids.

### SUMMARY OF THE INVENTION

Accordingly, it is an objective of the present invention to create a rechargeable battery substantially eliminating the above-cited drawbacks of the rechargeable batteries of the state of the art.

The terminology “foil rechargeable battery” herein shall denote a lithium polymer rechargeable battery such as described in the periodical MARKT & TECHNIK, Nr. 34, 1999, p 38, wherein an electrolytic gel is used. These batteries may, for instance, be fitted with a flexible external case. A rechargeable battery of this kind is known, for instance, as Panasonic SSP35623.6, which, however, is used in mobile telephones and also is optimized for that market. Rechargeable batteries based on lithium polymer technology are characterized by high energy densities of 250 watt-h per liter or 120 watt-h per kg and 500 charge/discharge cycles.

Comparable properties are also offered by the solid-state rechargeable battery developed in collaboration between the FRAUNHOFER INSTITUT FÜR SILIZIUMTECHNOLOGIE and the technical faculty of Kiel University and described for instance in the SCOPE periodical of November 1999 on pp 84, wherein a solid-state electrolyte replaces the heretofore mostly corrosive electrolytic liquid. Moreover, the solid-state electrolytes can be processed in a pressurized manner into foils and be made to assume any desired shape.

Both types of rechargeable batteries offer not only high energy densities and satisfactory recharging, but also allow wide variations in their geometries. This feature is made possible in that the electrolytes exhibit large chemical inertness and, as a result, the rigid, leak-proof and costly metal cases of conventional rechargeable batteries may be eliminated in favor of flexible external cases. However, to-date the rechargeable batteries have assumed a square shape.

It is the insight of the invention that the button cells heretofore used in hearing aids may be advantageously replaced by the above-mentioned solid-state or foil rechargeable batteries. A feature of these solid-state or foil rechargeable batteries to be exploited is that they can be made in arbitrary geometries and, so-to-speak, in customized form. Together with the improved energy density of the solid-state or foil rechargeable batteries compared to that of the button cells, such a design better utilizes the scant space within a hearing-aid case. The space that was used for the button cells is now superfluous and thus may be used in other ways, for instance to house electronic components, or the hearing aid may be made more compact.

In principle the rechargeable battery of the invention may be configured in an arbitrary external geometry and disposed at an arbitrary place within the housing. However, in an advantageous design the rechargeable battery shall match at least a portion of the hearing aid's housing inner surface. Easy shaping of the rechargeable batteries makes it possible to mount them on the inside wall of a portion of the housing. Although this feature entails abandoning the known cylindrical or parallelepipedic shapes of conventional rechargeable batteries, it does not create difficulties in the manufacture of foil or solid-state rechargeable batteries.

In principle, the rechargeable battery may be mounted anywhere inside the case. Illustratively, the solid-state or foil rechargeable battery may be in the shape of a button cell receptacle. However, only the improved energy density would then be exploitable, not the freedom to assume various shapes. Accordingly, this solution is not viewed as being optimal. If the hearing aid case consists, for instance, of a peripheral frame, a base plate, and a top plate, then the rechargeable battery according to the present invention may be advantageously mounted on the inside of the base plate or on the inside of the top plate or on both. In this manner optimal use is made of the space between the hearing aid's printed circuit board and the plate(s). The hearing aid may not need to be modified since this space is already present. The peripheral frame, per se, in general does not offer enough space to mount the rechargeable battery thereto.

In further accordance with the present invention, the rechargeable battery could be glued to the inside of a zone or portion of the case. Even though the battery is rechargeable, it may be necessary to exchange it and, advantageously, the rechargeable battery is designed to be exchangeable and is mounted accordingly.

In an especially advantageous manner, the rechargeable battery is mounted on the inside of a detachable plate. This feature facilitates accessing the rechargeable battery and allows the technician to easily and quickly access, remove, and replace the rechargeable battery. Moreover, the rechargeable battery may be exchanged together with the plate to the inside of which it is affixed. This is quickly carried out manually by the acoustic technician. However, even if the rechargeable battery were mounted on the inside surface of a permanent base plate, it still can be exchanged, though more laboriously, because first the electronic components configured in the hearing aid's peripheral frame must be removed in order to access the rechargeable battery.

The rechargeable battery must be electrically connected to the hearing aid's electric components. Therefore, the battery is fitted with appropriate terminals which, for instance when the lid is closed, will make contact with contact surfaces on the hearing aid's printed circuit board and thus implement electrical connection.

### BRIEF DESCRIPTION OF THE DRAWING

Further features and particulars of the invention are indicated in the attached drawing showing in illustrative and diagrammatic manner an exploded perspective view of a behind-the-ear hearing aid according to the present invention.

### DETAILED DESCRIPTION OF THE PREFERRED EMBODIMENT

The behind-the-ear hearing aid 1 consists of an ear hook 2 which adjoins an ear matching element (not shown). This ear matching element is a plastic cast of the outer auditory canal and implements acoustic transmission to the ear drum while suppressing feedback.

The ear hook 2 adjoins a case 3 of the hearing aid 1. The electronic components of the hearing aid 1 are mounted in this case 3. The case 3 is curved such that, when in use, the hearing aid is appropriately positioned behind the wearer's ear and makes contact over the largest possible surface.

In the shown embodiment, the case 3 consists of a peripheral frame 4, a detachable base plate 5, and a detachable cover plate 6. A printed circuit board 7 is mounted inside the frame 4 and seats the electronic circuits and components. The printed circuit board 7 is fitted at its lower end with two contacts 8 for making electrical contact with the negative or positive terminal 9 of a rechargeable battery 10. The lower sides facing the printed circuit board 7 may be spring-loaded in order to assure proper electrical contact between the positive and negative terminals 9 of the rechargeable battery 10 and the contacts 8 when the case 3 is closed.

In the embodiment shown, the top plate 5 and the base plate 6 each receive and hold a rechargeable battery 10 of the invention. Accordingly the printed circuit 7 has contacts 8 on its top and bottom sides.

Moreover, a microphone 11, an ear piece or speaker 12 and operating elements passing through the frame 4 are mounted within the frame. The hearing aid 1 can be activated/deactivated by the ON/OFF switch 13 and the volume can be adjusted by means of the volume control 14 illustratively in the form of a potentiometer.

Power to the hearing aid is provided by the rechargeable batteries 10 which, in the shown embodiment, are mounted one on the inside of the base plate 5 and one on the inside of the top plate 6. The batteries 10 substantially correspond to the topography of the inside surfaces of the associated two case parts (plates 5 and 6). At the side facing the printed circuit board 7, each rechargeable battery 10 has positive and negative terminals 9 that are aligned with corresponding contacts 8 fitted onto the printed circuit 7.

Both the base plate 5 and the top plate 6 can be detached in a snap-out manner from the frame 4. For that purpose each is fitted with peripheral snap-in pins 15 on the side facing the frame 4. The frame 4, in turn, is fitted with seats 16 in the form of through bores in reinforced frame zones 17. The seats 16 match the array and size of the snap-in pins and cooperate with the pins to secure the plates 5, 6 to the frame 4.

The above described solid-state or foil rechargeable batteries may be charged and discharged several hundred times. Recharging the batteries 10, for instance, may be carried out such that the batteries discharged through use are removed from the hearing aid by taking off its top or base plate and then are placed into a charger, for instance being configured on the inside surface of the plates, and the hearing aid being re-assembled following recharging. Such a procedure, however, is cumbersome.

Recharging may be carried out more simply using contacts that are situated at the outside surface of the base or top plate and that are electrically connected to the rechargeable batteries or a charging circuit, whereby the hearing aid can be placed as a whole into a corresponding charger. In this configuration the disassembly and re-assembly of the hearing aid is be avoided.

Alternatively, furthermore, recharging may be carried out inductively. The space freed by the elimination of the button cell might be used to house an appropriate charging circuit with a receiver coil.

What is claimed is:

1. A hearing aid (1) comprising a case (3), electronic components received within said case, and at least one rechargeable battery (10), wherein the rechargeable battery (10) is configured as a planar solid-state rechargeable battery or foil rechargeable battery.

2. The hearing aid (1) as claimed in claim 1, wherein the rechargeable battery (10) has a shape that at least approximately matches a shape of a portion of an inside surface of the case (3).

3. The hearing aid (1) as claimed in claim 2, wherein the portion is a detachable plate that serves as a cover (5, 6).

4. The hearing aid (1) as claimed in claim 1, wherein the rechargeable battery (10) is removable and replaceable.

5. Application of planar solid-state rechargeable battery or a foil rechargeable battery (10) to power a hearing aid (1).

6. The application of a rechargeable battery (10) as claimed in claim 5, wherein the rechargeable battery (10) is disposed within a housing of the hearing aid and, wherein the battery has a shape that at least approximately matches a shape of a portion of an inside surface of the housing (3).

7. The application of a rechargeable battery (10) as claimed in claim 6, wherein the portion is a detachable plate that serves as a cover (5, 6).

8. The application of a rechargeable battery (10) as claimed in claim 5, wherein the rechargeable battery (10) is removable and replaceable.
